(19) United States
(12) Patent Application Publication
(10) Pub. No.: US 2026/0064471 A1
(43) Pub. Date: Mar. 5, 2026

(54) SCHEDULING RESOURCES

(71) Applicant: Dell Products L.P., Round Rock, TX (US)

(72) Inventors: Xingshan Wang, Shanghai (CN); Chark Wenshuai Yu, Shanghai (CN); Bofan Liu, Jiangsu (CN); Xiaochen Liu, Shanghai (CN); Haiyan He, Shanghai (CN); Gary Jialei Wu, Shanghai (CN); Wanyu Wang, Yangpu (CN); Sheng Ni, Shanghai (CN); Chunru Liu, Shanghai (CN); Xiaoda Pan, Shanghai (CN); Wesley Peng, Shanghai (CN)

(21) Appl. No.: 18/927,723

(22) Filed: Oct. 25, 2024

(30) Foreign Application Priority Data
Aug. 30, 2024 (CN) 202411218574.6

(51) Int. Cl. G06F 9/50

(52) U.S. Cl. CPC G06F 9/5027

(57) ABSTRACT

The subject technology relates to scheduling resources. For instance, an example method determines containers running on cores of a processor. The method further includes acquiring parameters of the containers. The method further includes determining a designated core from the cores that is adapted to a target container in the containers based on the parameters and a scheduling policy. The method further includes scheduling the target container in the containers to run on the designated core adapted to the container. In this way, containers can be scheduled to processor cores that are most suitable for their running, so that the response speed of services is increased and the mutual interference of resource contention between cores is reduced, thus improving the resource utilization and overall performance of the system.

### RELATED APPLICATION

The present application claims the benefit of priority to Chinese Patent Application No. 202411218574.6, filed on Aug. 30, 2024, which application is hereby incorporated into the present application by reference herein in its entirety.

### TECHNICAL FIELD

The present disclosure relates to the field of resource management and, for example, to a method, a device, and a computer program product for scheduling resources.

### BACKGROUND

As data volumes proliferate and applications become more complex, storage systems face challenges of efficient management. Currently, the container technology provides a lightweight virtualization solution in which containers can encapsulate and manage applications and their dependencies, and package an application and its runtime environment into a stand-alone unit that runs in an isolated environment. Containers, in order to execute their internal applications, need to be allocated to run on cores of the central processing unit (CPU) so as to utilize the computing power of the CPU.

In the current Kubernetes (K8S) system and similar systems with container orchestration functions, different containers in a deployment unit (Pod) can be allocated different levels of CPU computing resources. These systems can allocate the required numbers of CPU cores to containers according to their actual needs. In this way, it can be ensured that each of the containers can obtain enough computing power to perform its tasks.

### SUMMARY

Embodiments of the present disclosure propose a method, a device, and a computer program product for scheduling resources.

In a first example embodiment of the present disclosure, a method for scheduling resources is provided. The method determines a plurality of containers running on a plurality of cores of a processor. The method further includes acquiring a plurality of parameters of the plurality of containers. The method further includes determining a designated core from the plurality of cores that is adapted to a target container in the plurality of containers based on the plurality of parameters and a scheduling policy. The method further includes scheduling the target container in the plurality of containers to run on the designated core adapted to the container.

In a second example embodiment of the present disclosure, an electronic device is provided. The electronic device includes one or more processors; and a storage apparatus for storing one or more programs, where the one or more programs, when executed by the one or more processors, cause the one or more processors to implement a method for scheduling resources. The method determines a plurality of containers running on a plurality of cores of a processor. The method further includes acquiring a plurality of parameters of the plurality of containers. The method further includes determining a designated core from the plurality of cores that is adapted to a target container in the plurality of containers based on the plurality of parameters and a scheduling policy. The method further includes scheduling the target container in the plurality of containers to run on the designated core adapted to the container.

In a third example embodiment of the present disclosure, a computer-readable storage medium is provided that has a computer program stored thereon, where the program, when executed by a processor, implements a method for scheduling resources. The method determines a plurality of containers running on a plurality of cores of the processor. The method further includes acquiring a plurality of parameters of the plurality of containers. The method further includes determining a designated core from the plurality of cores that is adapted to a target container in the plurality of containers based on the plurality of parameters and a scheduling policy. The method further includes scheduling the target container in the plurality of containers to run on the designated core adapted to the container.

It should be understood that the content described in the Summary of the Invention section is neither intended to limit key or essential features of the embodiments of the present disclosure, nor intended to limit the scope of the present disclosure. Other features of the present disclosure will become readily understood from the following descriptions.

### BRIEF DESCRIPTION OF THE DRAWINGS

The above and other features, advantages, and aspects of the embodiments of the present disclosure will become more apparent with reference to the accompanying drawings and the following detailed description. In the accompanying drawings, identical or similar reference numerals represent identical or similar elements, in which:

FIG. 1 illustrates a schematic diagram of an example environment in which example embodiments of the present disclosure can be implemented;

FIG. 2 illustrates a flow chart of a method for scheduling resources according to some example embodiments of the present disclosure;

FIG. 3 illustrates a schematic diagram of a process for scheduling containers according to some example embodiments of the present disclosure;

FIG. 4 illustrates a flow chart of a process for determining a designated core for a target container according to some example embodiments of the present disclosure;

FIG. 5 illustrates a schematic diagram of the effect after scheduling containers according to some example embodiments of the present disclosure;

FIG. 6 illustrates a schematic diagram of comparison of data transmission rates between the related art and some example embodiments according to the present disclosure; and

FIG. 7 illustrates a block diagram of a device that can implement example embodiments of the present disclosure.

### DETAILED DESCRIPTION

The embodiments of the present disclosure will be described below in further detail with reference to the accompanying drawings. Although the accompanying drawings show some embodiments of the present disclosure, it should be understood that the present disclosure may be implemented in various forms, and should not be interpreted as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the scope of protection of the present disclosure.

In the description of the embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or the same objects. Other explicit and implicit definitions may also be included below.

As mentioned above, current service deployment methods, such as container management in the K8S system, although providing a CPU resource request and limitation mechanism that can provide containers with the required number of cores, cannot allocate the most suitable CPU cores according to the specific needs of the containers, which may lead to uneven allocation of resources. For example, some containers may be provided with CPU resources far in excess of their needs, while other containers may suffer performance constraints due to insufficient resources, resulting in a reduction in the processing speed.

In addition, since the resource pool of the CPU is in a shared state, using the method of allocating cores to different containers to satisfy only the quantity demands, the system may suffer from mutual interference among different cores due to frequent task switching and CPU resource contention when dealing with writing that requires high throughput and frequent Secure Sockets Layer protocol layer (SSL) encryption operations. Such interference not only adds extra system overhead, but also directly affects the response speed and overall performance of the services, especially for the latency-sensitive applications, such as the Object Storage Service (OBS) in the K8S system, where the performance degradation is particularly significant.

To this end, embodiments of the present disclosure propose a scheme for scheduling resources. In the method, a plurality of parameters of a plurality of containers running on cores of a processor are acquired, a designated core is determined from the plurality of cores that is adapted to a target container in the plurality of containers according to the acquired plurality of parameters and a scheduling policy, and then the target container in the plurality of containers is scheduled to run on the designated core adapted to the container. In this way, containers can be scheduled to processor cores that are most suitable for their running, so that the response speed of services is increased and the mutual interference of resource contention between cores is reduced, thus improving the resource utilization and overall performance of the system.

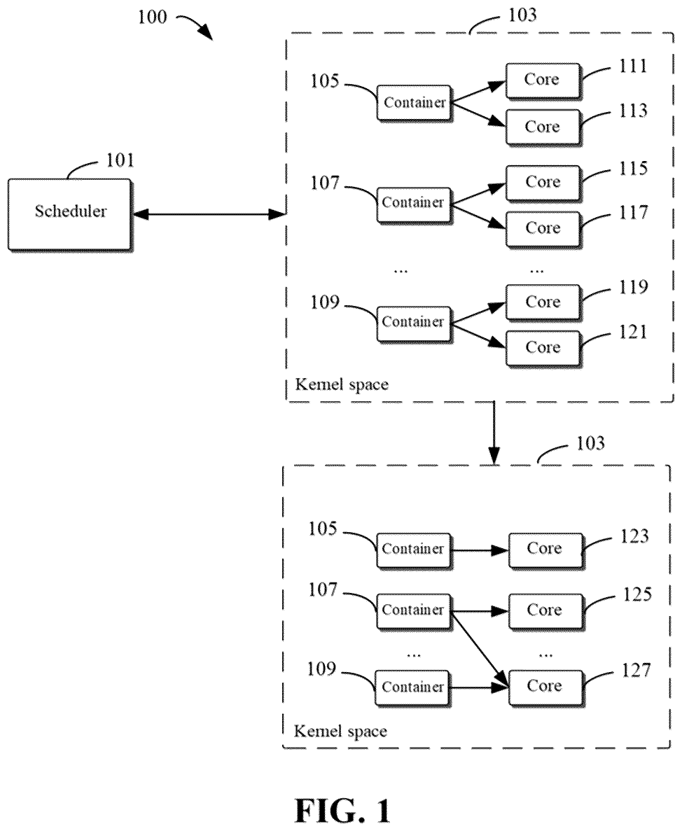

FIG. 1 illustrates a schematic diagram of an example environment 100 in which a plurality of embodiments of the present disclosure can be implemented. As shown in FIG. 1, the example environment 100 may include a scheduler 101. The scheduler 101 may be a component responsible for managing and allocating CPU resources of the system and, in embodiments of the present disclosure, the scheduler 101 is used to monitor and manage the states of available resources in the system. The example environment 100 may also include kernel space 103. The kernel space 103 is used to manage hardware resources and provide system services, and to ensure the stability and security of the system. The kernel space is relative to the user space, where the latter is the environment in which applications run, while the kernel space interacts directly with the system hardware.

In embodiments of the present disclosure, the example environment 100 may further include a plurality of containers as well as cores, where the container is used for deployment, distribution, and running of applications, and the core is a stand-alone execution unit within the processor, and each core can independently execute a sequence of instructions, process data, and communicate with the other parts of the CPU when necessary. The kernel space 103 can provide a running environment for the containers and cores. When an application within the container needs to perform computing tasks, these tasks will be allocated to the cores of the CPU for execution, and the performance of the cores can affect the execution efficiency and response speed of the application within the container.

As shown in FIG. 1, when the system receives a computing task, it allocates different numbers of cores to the containers in accordance with the computing resource required by each container. For example, cores 111 and 113 are allocated to the container 105, cores 115 and 117 are allocated to the container 107, and cores 119 and 121 are allocated to the container 109. Each container is allocated with at least two cores, and the allocated cores are used exclusively. For example, when the core 111 is allocated to the container 105, the core 111 will not be allocated to other containers. In addition, when the system schedules containers, the cores allocated are randomized. For example, if the number of cores required by the container 105 is 2 and the total number of cores of the CPU is 128, the system randomly selects two cores from these 128 cores and then schedules the container 105 to run on the selected cores. This random scheduling policy may result in situations where containers cannot be scheduled to the optimal cores, which in turn leads to the problem of low efficiency in task execution, resulting in the inability to achieve optimal configuration and efficient utilization of resources.

In embodiments of the present disclosure, a scheduling policy may be configured in the scheduler 101. The scheduling policy defines rules and algorithms to be followed by the scheduler 101 when performing task scheduling. Different scheduling policies are applicable to different application scenarios and needs. The scheduling policy can be adjusted according to the system conditions, and the present disclosure does not limit the content of the scheduling policy. The scheduler 101 may periodically acquire information about containers running on all cores and determine a plurality of parameters of each container. The plurality of parameters may include various types of parameters of each container, such as priority, data throughput, input/output intensity, demand amount of resources, and node affinity, which may be selected according to actual needs.

In some embodiments, after determining the plurality of parameters of each container, the scheduler 101 may determine, according to the scheduling policy and the plurality of parameters, an adapted designated core for a target container from the plurality of cores, i.e., find cores that are most suitable for running for containers with different specific requirements. The target container can be a newly created container or a container that is running but needs to have resource allocation adjusted. As shown in FIG. 1, after determining the designated core for the target container, the scheduler 101 schedules the target container to the designated core adapted to that container by accessing the kernel space 103. In embodiments of the present disclosure, the same core may be used exclusively, or may be shared by a plurality of different containers, and the number of designated cores for one target container may be one or more. For example, the container 105 is adapted to a core 123, the container 107 is adapted to a core 125 and a core 127, and the container 107 and the container 109 may run on the core 127 by means of time slice sharing.

According to an embodiment of the present disclosure, a plurality of parameters of a plurality of containers running on cores of a processor are acquired, a designated core is determined from the plurality of cores that is adapted to a target container in the plurality of containers according to the acquired plurality of parameters and a scheduling policy, and then the target container in the plurality of containers is scheduled to run on the designated core adapted to the container. In this way, containers can be scheduled to CPU cores that are most suitable for their running, which can improve the performance of an application, avoid resource contention and waste, and ensure that each core carries the most suitable task, which improves the overall resource utilization.

It should be understood that the architecture and function in the example environment 100 are described merely for illustrative purposes, and do not imply any limitation to the scope of the present disclosure. The embodiments of the present disclosure may also be applied to other environments having different structures and/or functions.

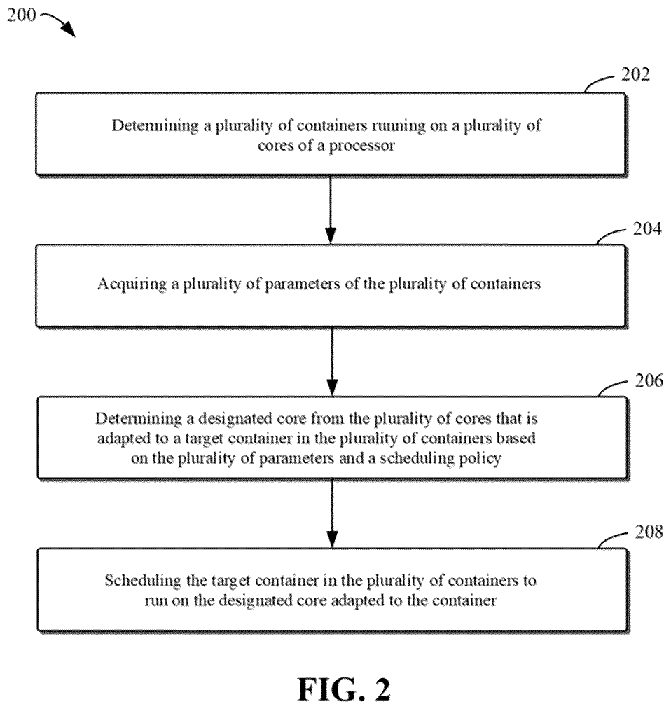

The process in the embodiments of the present disclosure will be described in detail below with reference to FIGS. 2 to 6. For ease of understanding, the specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 2 illustrates a flow chart of a method 200 for synchronizing data according to some embodiments of the present disclosure. At block 202, a plurality of containers running on a plurality of cores of a processor are determined. For example, as shown in FIG. 1, a plurality of containers running on a plurality of cores of the processor may be periodically determined by the scheduler 101 so that the correspondence between the plurality of containers randomly allocated and the plurality of cores may be obtained. For example, the containers running on the plurality of cores include the container 105, the container 107, and the container 109, where the container 105 is running on the core 111 and the core 113, the container 107 is running on the core 115 and the core 117, and so on, such that information about all the containers and the correspondence between them and the cores can be determined.

At block 204, a plurality of parameters of the plurality of containers are acquired. For example, as shown in FIG. 1, the scheduler 101 may periodically acquire information about containers running on all cores, and then determine a plurality of parameters of each container according to the container information. The plurality of parameters may include various types of parameters of each container, such as priority, data throughput, input/output intensity, demand amount of resources, and node affinity. The types of the parameters can be specifically selected according to actual needs, specifically to meet the purpose of improving resource utilization, which is not limited by the present disclosure.

At block 206, a designated core that is adapted to a target container in the plurality of containers is determined from the plurality of cores based on the plurality of parameters and a scheduling policy. For example, as shown in FIG. 1, after determining the plurality of parameters of each container, the scheduler 101 may determine, according to the scheduling policy and the plurality of parameters, an adapted designated core for the target container from the plurality of cores. The target container may be a container with specific resource requirements or operational characteristics, including, but not limited to, a compute-intensive container, a memory-intensive container, a network-intensive container, and the like. In embodiments of the present disclosure, the scheduler 101 may determine adapted cores for different target containers according to the plurality of parameters of each target container. For example, it may designate cores that are close to I/O devices for containers with high input/output (I/O) intensity, designate cores that have higher performance and larger caches for those that perform a large number of computing tasks, designate cores that have higher security for containers that process sensitive data, and so on.

At block 208, the target container in the plurality of containers is scheduled to run on the designated core adapted to the container. For example, as shown in FIG. 1, after determining the designated core for the target container, the scheduler 101 schedules the target container to the designated core adapted to that container by accessing the kernel space 103. In embodiments of the present disclosure, the same core may be used exclusively, or may be shared by a plurality of different containers, and the number of designated cores for one target container may be one or more. For example, the container 105 is adapted to a core 123, the container 107 is adapted to a core 125 and a core 127, and the container 107 and the container 109 may run on the core 127 by means of time slice sharing.

In some embodiments, when a plurality of containers share the same core, a detection can be made as to whether there is interference on that core, for example, CPU time slice contention, cache invalidation, and the like, and if there is interference, part of the plurality of containers can be transferred away from this core. For example, as shown in FIG. 1, one of the container 107 and the container 109 may be transferred away from the core 127 when there is interference on the core 127. By migrating containers from cores that are subject to interference to cores that are subject to less or no interference, resource contention and cache invalidation can be reduced, thereby improving the execution efficiency and performance of the containers.

In this way, containers can be scheduled to CPU cores that are most suitable for their running, so that the response speed of services is increased and the mutual interference of resource contention between cores is reduced, and the cores can be shared by several containers that are not on the critical path, thus further improving the resource utilization and overall performance of the system.

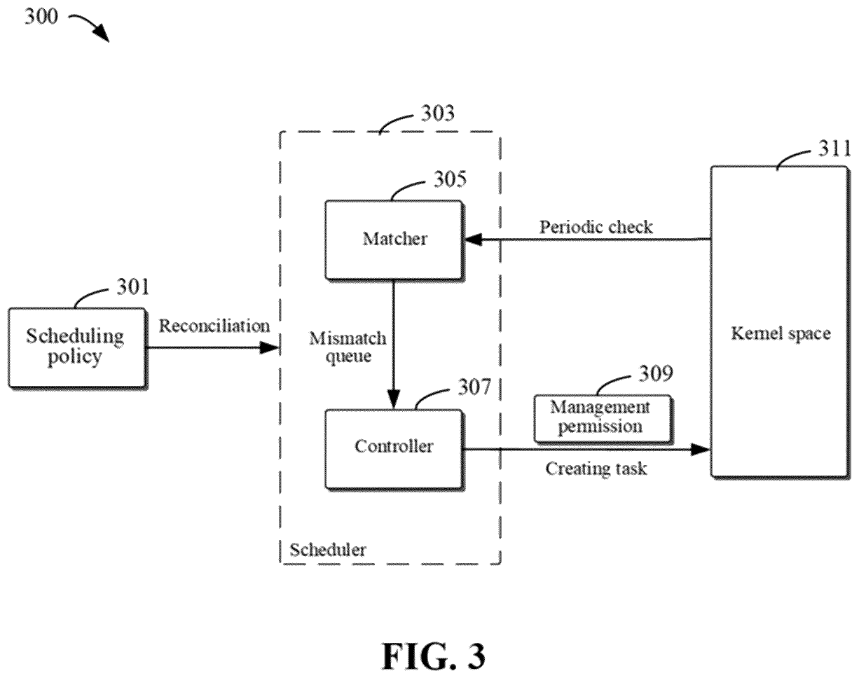

An example process for scheduling resources will be specifically described below in conjunction with FIGS. 3 to 7. In embodiments of the present disclosure, explanatory descriptions are provided in the order of the process of scheduling containers, determining a designated core for a target container, the effect after scheduling containers, and comparing the effect of the scheme of the present disclosure after implementation and that of the related art. The specific data mentioned in the following description are all illustrative and are not intended to limit the scope of protection of the present disclosure. It should be understood that the embodiments described below may also include additional actions not shown and/or may omit actions shown, and the scope of the present disclosure is not limited in this regard.

FIG. 3 illustrates a schematic diagram of a process 300 for scheduling containers according to some embodiments of the present disclosure. As shown in FIG. 3, a scheduler 303 configured with a scheduling policy 301 may include a matcher 305. The matcher 305 may periodically acquire information about a plurality of containers running on a plurality of cores of the processor by accessing kernel space 311 through a kernel interface of a control group (cgroup), so as to determine a plurality of parameters of each container, and determine which are target containers according to the plurality of parameters. After determining the target container, the matcher 305 may obtain the actual value of the target container, which is used to indicate the core in which the target container currently resides, and then may determine an expected value of the target container by means of the scheduling policy 301, which is used to indicate the core adapted to the target container. When the actual value does not match the expected value, it indicates that the target container is not running on the adapted core, and the target container is then placed in a mismatch queue.

The scheduler 303 may also include a controller 307. The controller 307 is used to process the mismatch queue from the matcher 305 and schedule the mismatched target container to run on a designated core adapted to that container by means of a management permission 309. For example, in a Linux system, a mismatch queue processing operation may be performed by means of the cpuset mechanism provided by the Linux kernel. When the controller 307 decides that a certain target container needs to be migrated from the current core to another core, the controller 307 can update the cpuset configuration of that container by operating the cpuset sysfs interface in the kernel. sysfs is a virtual file system that provides a window to view and modify data structures in the kernel. By writing new CPU core information to the cpuset sysfs, once the cpuset configuration is updated, the Linux kernel will ensure that the container runs on the designated core. In this way, the controller 307 successfully completes the rescheduling operation for the mismatched container by modifying the cpuset configuration and making it effective. In embodiments of the present disclosure, management of containers and CPU cores is achieved by the scheduler 303 including the matcher 305 and the controller 307, so the configurations of containers and cores can be retained and restored under specific conditions such as service restart.

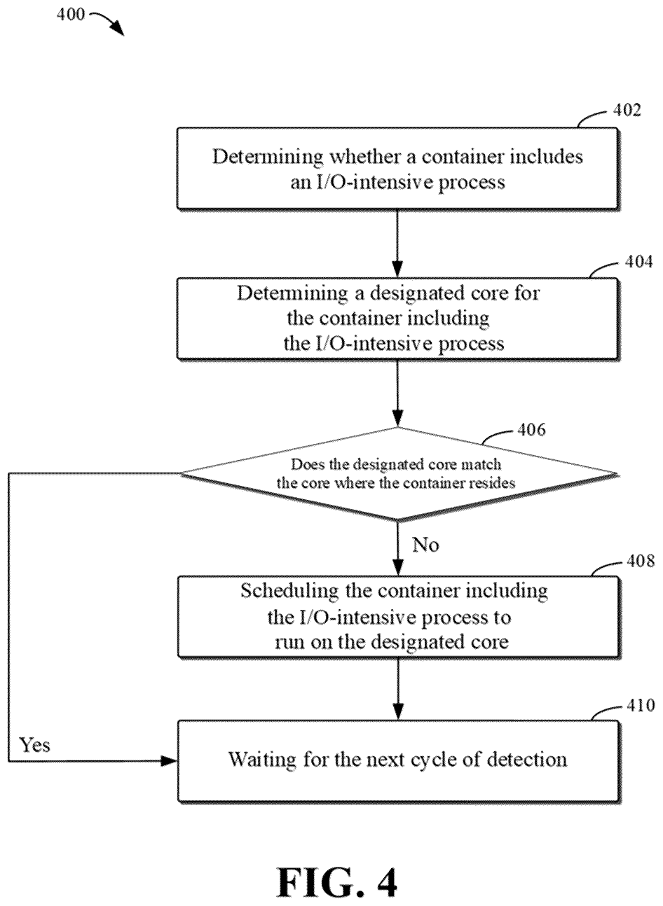

FIG. 4 illustrates a flow chart of a process 400 for determining a designated core for a target container according to some embodiments of the present disclosure. At block 402, it is determined whether a container includes an I/O-intensive process. For example, as shown in FIG. 3, a plurality of parameters of each container may be periodically acquired by the matcher 305. The parameters may include I/O intensity, and when the I/O intensity of the container is greater than a set threshold, it may be determined that the container includes an I/O-intensive process.

At block 404, a designated core for the container including the I/O-intensive process is determined. For example, as shown in FIG. 3, a designated core for the container including the I/O-intensive process may be determined by the matcher 305 according to the scheduling policy 301. An I/O-intensive process is a process that requires a large number of input/output (I/O) operations during execution, such as database query, file reading and writing, and network communication. Since I/O-intensive processes frequently interact with input/output devices (e.g., hard disks, network interfaces, etc.) during their execution, the performance of these processes is often limited by the latency and bandwidth of I/O operations. In embodiments of the present disclosure, the designated core for the container including the I/O-intensive process may be a core that is physically close to an I/O device connected to the processor. For example, the designated core may be a core that is in close proximity to a storage devices or a network interface card on a PCI-E bus, or it may also be a core that has a higher bandwidth connection to these devices via an internal bus.

At block 406, it is determined whether the designated core matches the core where the container resides. For example, as shown in FIG. 3, the matcher 305 may acquire an actual value and an expected value of the container including the I/O-intensive process, and determine whether the container including the I/O-intensive process is running on the designated core by comparing the actual value and the expected value. At block 408, in response to a mismatch between the designated core and the core where the container resides, the container including the I/O-intensive process is scheduled to run on the designated core. For example, as shown in FIG. 3, the mismatched target container may be scheduled by the controller 307 to run on the designated core adapted to that container based on the received mismatch queue and the management permission 309. In embodiments of the present disclosure, by scheduling the I/O-intensive process to the designated core, the latency and conflicts of I/O operations can be minimized and the data transmission rate can be increased, thereby improving the utilization of system resources and the overall performance. At block 410, in response to a match between the designated core and the core where the container resides, the process waits for the next cycle of detection.

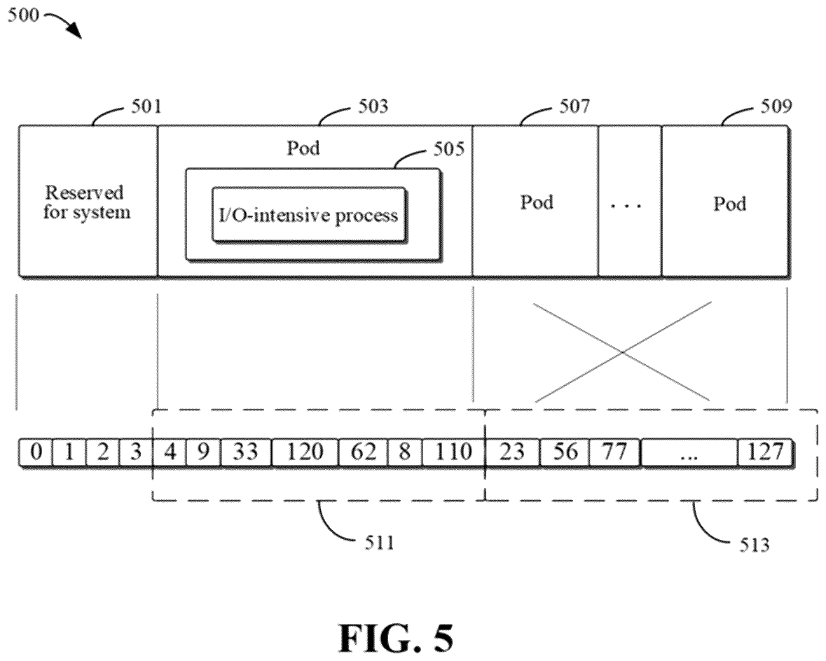

FIG. 5 illustrates a schematic diagram of the effect 500 after container scheduling according to some embodiments of the present disclosure. As shown in FIG. 5, the CPU includes a total of 128 cores numbered 0 to 127, and the cores reserved for the system are those numbered 0 to 3. A core set 511 adapted to a container 505 that includes an I/O-intensive process includes cores numbered 4, 9, 33, 120, 62, 8, and 100, and a Pod 503 to which the container 505 belongs may include one or more containers 505. When the Pod 503 includes only one container 505, the core set 511 may be occupied exclusively by the container 505, which reduces context switching, improves cache hit rates, and reduces resource contention, thereby improving the performance and stability of the container 505. In some embodiments, a plurality of Pods, such as a Pod 507 and a Pod 509, may also be included, and for Pods that do not include containers with specific requirements and running characteristics, a core set 413 may be shared to reduce unnecessary waste of resources.

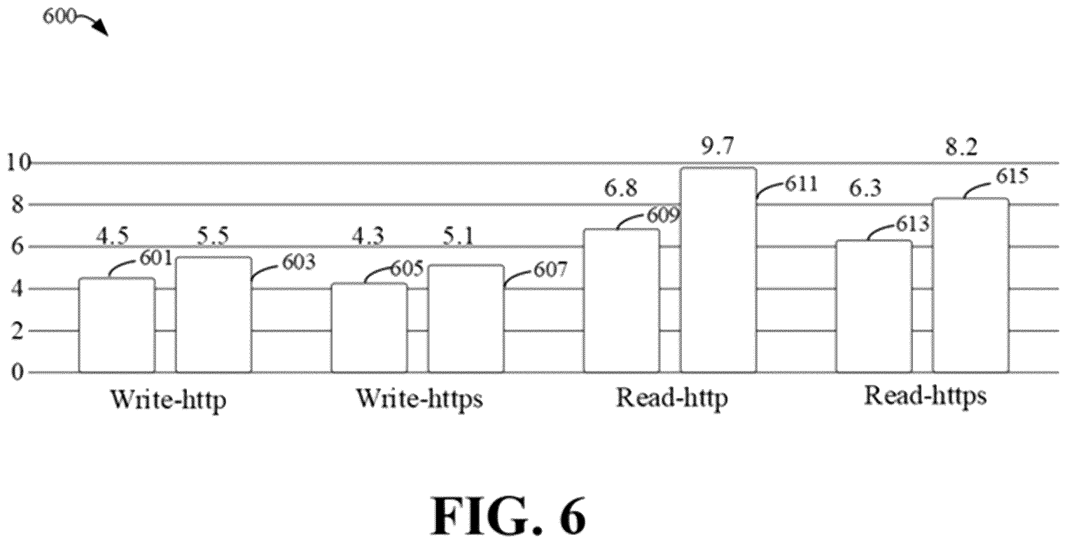

FIG. 6 illustrates a schematic diagram of comparison 600 of data transmission rates between the related art and some embodiments according to the present disclosure. In order to demonstrate the beneficial effects of some embodiments of the present disclosure, the experimental scheme and its results are described below. Testing premises are as shown in Table 1:

TABLE 1

| Component | Description |
|---|---|
| Central processing unit | Intel(R) Xeon(R) Gold 6430, 2 sockets, 128 |
| | cores |
| Dynamic random access | 256GB, DDR5 |
| memory | |
| Operating system | SUSE Linux Enterprise Server 15 (x86_64); |
| | VERSION = 15; PATCHLEVEL = 4 |
| Front-end network | Mellanox MT2892 Family [ConnectX-6 Dx], |
| interface card | 200 Gb/s |
| Back-end network | Mellanox MT2892 Family [ConnectX-6 Dx], |
| interface card | 200 Gb/s |
| Loading tool | Mongoose-4.3.2 |

As shown in FIG. 6, according to the container scheduling of the related art, the data transmission rate of a write-Hypertext Transfer Protocol (http) 601 is “4.5 GB/s”; while according to the container scheduling method of the present disclosure, the data transmission rate of a write-http 603 is “5.5 GB/s.” According to the container scheduling of the related art, the data transmission rate of a write-Hypertext Transfer Secure Protocol (https) 605 is “4.3 GB/s”; while according to the container scheduling method of the present disclosure, the data transmission rate of a write-https 607 is “5.1 GB/s.” According to the container scheduling of the related art, the data transmission rate of a read-http 609 is “6.8 GB/s”; while according to the container scheduling method of the present disclosure, the data transmission rate of a read-http 611 is “9.7 GB/s.” According to the container scheduling of the related art, the data transmission rate of a read-https 613 is “6.3 GB/s”; while according to the container scheduling method of the present disclosure, the data transmission rate of a read-https 615 is “8.2 GB/s.” It can be seen that for both the http and https protocols, there is an increase in the data transmission rate using the container scheduling method of the present disclosure compared with container scheduling of the related art. Specifically, there is a significant increase in the data transmission rate for both write operations and read operations.

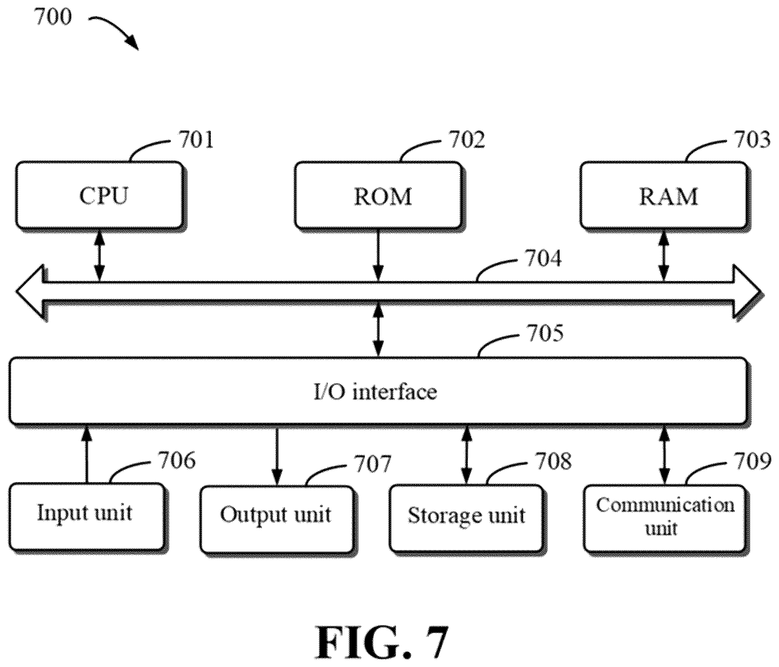

FIG. 7 illustrates a schematic block diagram of an example device 700 which can be used to implement embodiments of the present disclosure. As shown in the figure, the device 700 includes a computing unit 701 that can perform various appropriate actions and processing according to computer program instructions stored in a read-only memory (ROM) 702 or computer program instructions loaded from a storage unit 708 to a random access memory (RAM) 703. Various programs and data required for the operation of the device 700 may also be stored in the RAM 703. The computing unit 701, the ROM 702, and the RAM 703 are connected to each other via a bus 704. An Input/Output (I/O) interface 705 is also connected to the bus 704.

Multiple components in the device 700 are connected to the I/O interface 705, including: an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices via a computer network, such as the Internet, and/or various telecommunication networks.

The computing unit 701 may be various general-purpose and/or special-purpose processing components with processing and computing powers. Some examples of the computing unit 701 include, but are not limited to, central processing units (CPUs), graphics processing units (GPUs), various specialized artificial intelligence (AI) computing chips, various computing units for running machine learning model algorithms, digital signal processors (DSPs), and any appropriate processors, controllers, microcontrollers, etc. The computing unit 701 performs various methods and processes described above, such as the method 200. For example, in some embodiments, the method 200 may be implemented as a computer software program that is tangibly included in a machine readable medium, such as the storage unit 708. In some embodiments, part or all of the computer program may be loaded and/or installed onto the device 700 via the ROM 702 and/or the communication unit 709. When the computer program is loaded to the RAM 703 and executed by the computing unit 701, one or more steps of the method 200 described above may be performed. Alternatively, in other embodiments, the computing unit 701 may be configured to implement the method 200 in any other suitable manners (such as by means of firmware).

The functions described hereinabove may be executed at least in part by one or more hardware logic components. For example, without limitation, example types of available hardware logic components include: a Field Programmable Gate Array (FPGA), an Application Specific Integrated Circuit (ASIC), an Application Specific Standard Product (ASSP), a System on Chip (SOC), a Load Programmable Logic Device (CPLD), and the like.

Program codes for implementing the methods of the present disclosure may be written by using one programming language or any combination of multiple programming languages. The program code may be provided to a processor or controller of a general purpose computer, a special purpose computer, or another programmable data processing apparatus, such that the program code, when executed by the processor or controller, implements the functions/operations specified in the flow charts and/or block diagrams. The program code may be executed completely on a machine, executed partially on a machine, executed partially on a machine and partially on a remote machine as a stand-alone software package, or executed completely on a remote machine or server.

In the context of the present disclosure, a machine-readable medium may be a tangible medium that may include or store a program for use by an instruction execution system, apparatus, or device or in connection with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include one or more wire-based electrical connections, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. Additionally, although operations are depicted in a particular order, it should be understood that such operations are required to be performed in the particular order shown or in a sequential order, or that all illustrated operations should be performed to achieve desirable results. Under certain environments, multitasking and parallel processing may be advantageous. Likewise, although the above discussion contains several specific implementation details, these should not be construed as limitations to the scope of the present disclosure. Certain features that are described in the context of separate embodiments may also be implemented in combination in a single implementation. Conversely, various features that are described in the context of a single implementation may also be implemented in a plurality of implementations separately or in any suitable sub-combination.

Although the present subject matter has been described using a language specific to structural features and/or method logical actions, it should be understood that the subject matter defined in the appended claims is not necessarily limited to the particular features or actions described above. Rather, the specific features and actions described above are merely example forms of implementing the claims.

What is claimed is:

1. A method, comprising:
determining containers running on cores of a processor;
acquiring parameters of the containers;
determining a designated core from the cores that is adapted to a target container in the containers based on the parameters and a scheduling policy; and
scheduling the target container in the containers to run on the designated core adapted to the container.

2. The method according to claim 1, wherein determining the designated core from the cores that is adapted to the target container in the containers comprises:
for each container of the containers,
determining, based on the parameters of the containers, whether each container comprises an input/output-intensive process; and
in response to the container being determined to comprise the input/output-intensive process, determining at least one designated core for the container comprising the input/output-intensive process.

3. The method according to claim 2, wherein the processor is connected to an input/output device,
wherein determining the at least one designated core for the container comprising the input/output-intensive process comprises:
determining the at least one designated core for the container comprising the input/output-intensive process by a scheduler based on the scheduling policy, and
wherein a distance from the at least one designated core to the input/output device is less than a distance from a core, in which a non-input/output-intensive process resides, to the input/output device.

4. The method according to claim 3, wherein the scheduler comprises a matcher and a controller, and wherein scheduling the target container in the containers to run on the designated core adapted to the container comprises:
determining, by the matcher, whether the core, in which the container comprising the input/output-intensive process resides, matches the at least one designated core; and
scheduling, by the controller, the container comprising the input/output-intensive process to run on the at least one designated core in response to the core, in which the input/output-intensive process resides, not matching the at least one designated core.

5. The method according to claim 4, wherein scheduling, by the controller, the container comprising the input/output-intensive process to run on the at least one designated core comprises:
scheduling the container comprising the input/output-intensive process to run on the at least one designated core based on an access to core space by the controller using a configuration permission and a core interface.

6. The method according to claim 1, wherein the designated core is a first designated core, wherein the cores comprise a first core, wherein the containers comprise a first container and a second container, and wherein scheduling the target container in the containers to run on the first designated core adapted to the container comprises:
scheduling the first container and the second container to run on a second designated core adapted to the first container and the second container, wherein the first container and the second container run on the second designated core using time slice sharing.

7. The method according to claim 6, further comprising:
detecting whether there is interference on the second designated core; and
in response to the interference being detected on the second designated core, transferring the first container or the second container away from the second designated core.

8. The method according to claim 1, wherein acquiring the parameters of the containers comprises:
acquiring a priority, a data throughput, and an input/output intensity of each of the containers.

9. A device, comprising:
at least one processor; and
at least one memory coupled to the at least one processor and having instructions stored thereon, wherein the instructions, when executed by the at least one processor, cause the device to perform operations, comprising:
determining a group of containers running on a group of cores of a processor;
acquiring a group of parameters of the group of containers;
determining a designated core from the group of cores that is adapted to a target container in the group of containers based on the group of parameters and a scheduling policy; and
scheduling the target container in the group of containers to run on the designated core adapted to the container.

10. The device according to claim 9, wherein the determining of the designated core from the group of cores that is adapted to the target container in the group of containers comprises:
determining, based on at least one respective parameter of the group of parameters of each container, whether each container comprises an input/output-intensive process; and
determining at least one first designated core for the container comprising the input/output-intensive process in response to the container comprising the input/output-intensive process.

11. The device according to claim 10, wherein the processor is connected to an input/output device,
wherein the determining of the at least one first designated core for the container comprising the input/output-intensive process further comprises:
determining the at least one first designated core for the container comprising the input/output-intensive process by a scheduler based on the scheduling policy, and
wherein a distance from the at least one first designated core to the input/output device is less than a distance from a core, in which a non-input/output-intensive process resides, to the input/output device.

12. The device according to claim 11, wherein the scheduler comprises a matcher and a controller, wherein the scheduling of the target container in the group of containers to run on the designated core adapted to the container further comprises:
determining, by the matcher, whether the core, in which the container comprising the input/output-intensive process resides, matches the at least one first designated core; and
scheduling, by the controller, the container comprising the input/output-intensive process to run on the at least one first designated core in response to the core, in which the input/output-intensive process resides, not matching the at least one first designated core.

13. The device according to claim 12, wherein the scheduling, by the controller, of the container comprising the input/output-intensive process to run on the at least one first designated core further comprises:
scheduling the container comprising the input/output-intensive process to run on the at least one first designated core based on an access to core space by the controller by means of a configuration permission and a core interface.

14. The device according to claim 9, wherein the designated core is a first designated core, wherein the group of cores comprises a first core, wherein the group of containers comprises a first container and a second container, and wherein the scheduling of the target container in the group of containers to run on the first designated core adapted to the container further comprises:
scheduling the first container and the second container to run on a second designated core adapted to the first container and the second container, wherein the first container and the second container run on the second designated core by means of time slice sharing.

15. The device according to claim 14, wherein the operations further comprise:
in response to detecting interference on the second designated core, transferring the first container or the second container away from the second designated core.

16. The device according to claim 9, wherein the acquiring of the group of parameters of the group of containers further comprises:
acquiring a respective priority, a respective data throughput, and a respective input/output intensity for each of the group of containers.

17. A computer program product, the computer program product being stored on a non-transitory computer-readable medium and comprising machine-executable instructions, wherein the machine-executable instructions, when executed, cause a machine to perform operations comprising:
determining a plurality of containers executing on a plurality of cores of a processor;
acquiring a plurality of parameters of the plurality of containers;
determining a designated core from the plurality of cores that is adapted to a target container in the plurality of containers based on the plurality of parameters and a scheduling policy; and
scheduling the target container in the plurality of containers to execute on the designated core adapted to the container.

18. The computer program product according to claim 17, wherein determining the designated core from the plurality of cores that is adapted to the target container in the plurality of containers comprises:
determining, based on respective ones of the plurality of parameters of each container, whether each container comprises an input/output-intensive process; and
determining at least one first designated core for the container comprising the input/output-intensive process in response to the container being determined to comprise the input/output-intensive process.

19. The computer program product according to claim 18, wherein the processor is connected to an input/output device, wherein determining the at least one first designated core for the container comprising the input/output-intensive process comprises determining the at least one first designated core for the container comprising the input/output-intensive process by a scheduler based on the scheduling policy, and wherein a distance from the first designated core to the input/output device is less than a distance from a core, in which a non-input/output-intensive process resides, to the input/output device.

20. The computer program product according to claim 19, wherein the designated core is a first designated core, wherein the scheduler comprises a matcher and a controller, wherein the processor is connected to the input/output device, and wherein execution instructions for scheduling the target container in the plurality of containers to execute on the first designated core adapted to the container comprise instructions for:
determining, by the matcher, whether the core, in which the container comprising the input/output-intensive process resides, matches the first designated core; and
scheduling, by the controller, the container comprising the input/output-intensive process to execute on the first designated core in response to the core, in which the input/output-intensive process resides, not matching the first designated core.
